(19) United States
(12) Patent Application Publication
(10) Pub. No.: US 2017/0099889 A1
(43) Pub. Date: Apr. 13, 2017

(54) HIGH STRESS RETENTION NITRILE GLOVE

(71) Applicant: DERLINK CO., LTD., TAIPEI (TW)

(72) Inventor: DER-LIN LIOU, TAIPEI CITY (TW)

(21) Appl. No.: 14/877,282

(22) Filed: Oct. 7, 2015

(51) Int. Cl. A41D 19/00; C08F 236/12

(52) U.S. Cl. CPC A41D 19/0082; C08F 236/12

(57) ABSTRACT

A glove with thickness from about 0.05 mm to 0.3 mm having stress retention greater than 50% at 100% stretch, tensile stress at break greater than 17 Mpa and elongation at break greater than 550% is made from a carboxylated acrylonitrile butadiene elastomer comprising 20-30% acrylonitrile, 63-77% butadiene and 3-7% carboxylic acid dry weight of elastomer and crosslinked by 1.0-4.0 phr aluminum ion compound.

### FIELD OF THE INVENTION

The present invention relates to the compositions of a high stress retention nitrile glove and method of making it.

### BACKGROUND OF THE INVENTION

Nitrile glove made from carboxylated acrylonitrile butadiene elastomer with advantages of good chemical resistant, high tensile strength and no protein allergy risk has become the main product to substitute natural rubber glove in the market. However, the commercial available nitrile glove elasticity and softness is not as good as natural rubber glove and not so comfortable and hand fitting for extended wearing. U.S. Pat. No. 5,014,362 disclosed a nitrile glove having stress after stretch 100% of its length for 6 minutes is less than 50% of its initial stress, and most of nitrile glove available in the market having stress retention about 30-45%, these gloves are easily stretched and comfortable, but will lost close-fitting after extended wearing caused by poor elasticity and stress retention. On the contrary, natural rubber glove having stress retention about 80-90% at 100% stretch, it can remain close-fitting even after wearing a long time. The conventional crosslinking method of natural rubber glove applying zinc oxide to active sulfur and using accelerator to speed up sulfur crosslinking with isoprene to form covalent bond for improving rubber hardness, strength and elasticity. Nitrile glove made from carboxylated nitrile elastomer comprising carboxylic acid function with zinc oxide to form ionic bond, and butadiene function with sulfur and accelerator to form covalent bond. Most of previously approaches by increased sulfur and accelerator content and decreased zinc oxide content so as to maximize covalent bond and minimize ionic bond created for improving elasticity and softness and stress retention, but with high dosage sulfur caused glove quality problems such as poor aging property, yellowish, bad smell odor, low tensile strength, and accelerator cause Type IV chemical allergy risk. For example, U.S. Pat. Nos. 6,451,893 and 7,176,270 disclosed a nitrile glove having stress retention greater than 50% and its crosslinking agent composition comprising 2.0-5.0 phr sulfur, 0.5-2.0 phr accelerator, 0-1.0 phr zinc oxide; U.S. Pat. No. 6,566,435 disclosed a nitrile glove having stress retention 50-70% and made from nitrile rubber comprising 2-6% methacrylic acid, and by using 1-3 phr sulfur, 0.5-1.5 phr accelerator, 0.1-0.5 phr zinc oxide as crosslinking agent, this approach required higher temperature and longer maturation time in the nitrile latex compound process to increase covalent bond formed, it is not effective for massive glove production; U.S. Pat. No. 7,273,906 disclosed a glove having stress retention greater than 70% is made from a carboxylated acrylonitrile butadiene latex which is processed by repeated adding variety amount of acrylonitrile monomer and methacrylic acid monomer at different polymerization stage, and by using crosslinking agent composition comprising 3.5-4.5 phr sulfur, 1-3 phr accelerator and less than 0.5 phr zinc oxide, this approach need to use a special processed nitrile latex that increase raw material cost and still required a high content of sulfur and accelerator.

The sulfur crosslinking method by using accelerator to boost up sulfur connecting speed with butadiene of carboxylated nitrile elastomer to form covalent bond, without accelerator it require a much higher energy and time for sulfur to function and create covalent bond, most of accelerator applied such as thiourea, thiuram, thiazole and carbamate cause Type IV chemical allergy risk. Therefore, the nitrile glove industry has been trying to avoid or reduce using accelerator, but most of them are not able to improve the stress retention or without any teaching of making a high stress retention nitrile glove. For example, U.S. Pat. No. 6,939,617 disclosed a non-adhesive emulsion latex product is made by adding a carboxylic group blocking agent such as aluminate or aluminum hydroxide gel to a carboxylated latex or by providing a layer treated with the carboxylic group blocking agent on one or both surfaces of a film of the carboxylated latex product, this approach without using sulfur and accelerator, but in actually practice, it caused latex early gelling, un-stability and uneven coating problems, and there is no teaching of improving stress retention; U.S. patent publication No. 20060057320 disclosed by using zinc oxide and alkoxyalkyl alkylol melamine for making an accelerator free nitrile glove, the melamine containing formaldehyde is a known human carcinogen; U.S. Pat. No. 8,044,138 disclosed a carboxylated nitrile copolymer latex comprising an unsaturated monomer having at least one crosslinkable functional group selected from vinyl and epoxy groups, and an article produced from the latex is absent sulfur and accelerator, and Japan patent No. 5184720 and 5275520 disclosed a glove made by carboxylated nitrile elastomer comprising 25-30% of acrylonitrile, 62-71% of butadiene and 4-8% of carboxylic acid crosslinked by bivalent metal ion and a vinyl compound for making a sulfur and accelerator free nitrile glove, these approaches with similar composition and provide a self-crosslinked nitrile latex is easy for glove makers to use, but with no teaching of making a high stress retention nitrile glove; U.S. Pat. No. 8,207,276 disclosed by adding emulsified organic peroxide to crosslink with carboxylated nitrile latex is able to make a dipping article with a stress retention greater than 50%, this approach without sulfur and accelerator problems, but it required to consider peroxide half-life and stability of the nitrile latex compound that is difficult to control in a continuously massive glove production, and the made article is tend to with a lower tensile strength; U.S. Pat. No. 8,389,620 disclosed a dip-forming composition comprising a carboxylated diene-based rubber latex and an organic metallic crosslinking agent containing one or more metal atom which is bonded to one or two carboxylated group of a carboxylic acid and two or more hydroxyl groups which are bonded to the metal atom, wherein the metal atom is aluminum or titanium, and the organic component is selected from nonionic, anionic or cationic property-deactived polyvinyl alcohol, polyamine base resin or carbohydrate, and the composition is further included a cationzing agent, hydrophobic substance, water-soluble polymer and magnesium and or calcium hydroxide, this approach composition is too complicated and difficult to execute in a massive glove production and without any teaching of improving stress retention; Japan patent publication No. 2014/074112 disclosed a carboxylated nitrile elastomer molded product crosslinked by a metallic ion to form ionic bond and dihydrazide compound to form covalent bond, the product is not comprising sulfur with accelerator as crosslinking agent and with less than 0.4% zinc content, this approach with low content of metallic ion which may cause poor tensile strength performance and without the teaching of making a high stress retention glove. In order to improve nitrile glove stress retention without or with reduced amount sulfur and accelerator, many efforts has been trying, but until now there is no successful approach without defect. Therefore, it is still having a continuous need of developing a high stress retention nitrile glove without or with reduced amount of accelerator and sulfur.

### SUMMARY OF THE INVENTION

The present invention provides a method without or with a reduced amount of accelerator and sulfur for making a high stress retention nitrile glove. There are many grade of carboxylated nitrile latex available in the market for glove industry, commonly with a solid elastomer content about 45% and composition range comprising about 20-40% acrylonitrile, 52-77% butadiene and 3-8% carboxylic acid dry weight of elastomer. Among the elastomer components, the hard segment of acrylonitrile can improve chemical resistant and hardness but it also make glove stiff, the soft segment of butadiene can be crosslinked by sulfur or peroxide to function with C═C double bond to form covalent bond for improving glove durability, softness, elasticity and part of strength, and the end function group carboxylic acid can be crosslinked by metallic ion to form ionic bond and some of crosslinking agents can function with hydroxy group of carboxylic acid to form covalent bond for improving glove strength and hardness and water resistant. Selecting a proper components ratio of carboxylated nitrile latex to make a high stress retention nitrile glove is very important, the preferred components range about 20-30% acrylonitrile, 63-77% and 3-7% carboxylic acid dry weight of carboxylated nitrile elastomer of present invention. Basically, glove physical performance is varied and depends on components ratio of carboxylated nitrile elastomer and the selected crosslinking agent types and its components ratio, to find out the best combination and balance ionic bond and covalent bond ratio is the key factor to make a good quality high stress retention glove with a minimum health risk. Comparing the impact between divalent and trivalent metallic ion to carboxylated nitrile elastomer, it was a surprise to find out that by using aluminum or zinc ion without using other crosslinking agent, the aluminum ion made glove having a much better physical performance such as with a better stress retention and elongation, lower stress at stretch, similar tensile strength and better wearing durability compare to zinc made glove. It is consider without by any theory that aluminum ion can build up stronger ionic bond and create higher crosslinking density compare to zinc ion. We have further tried many types of covalent bond crosslinking agents such as peroxide, polynitrile oxide, isocyanurate, silane, dihydrazide, diamine, melamine, carbodiimide, epoxy, dialdehyde and etc., and after examined test result and compared the relationship between different composition of carboxylated nitrile elastomer and crosslinking agents, it was found out and concluded that glove stress retention and wearing durability can be further improved by adding additional covalent bond crosslinking agents without using sulfur and accelerator. Based on the consideration of cost, user friendly and with a minimum health and environmental pollution risks to make a high stress retention and more comfortable nitrile glove for extended wearing, it is selected an aluminum ion, polyethylene glycol and dialdehyde derivatives compound as the preferred crosslinking agent of present invention, and also provide another solution of combining the present invention preferred crosslinking agent with a low dosage of sulfur, accelerator or zinc oxide to make an acceptable quality high stress retention nitrile glove with a reduced allergy risk, less bad sulfur smell odor and better aging property than previously approaches.

### DETAILED DESCRIPTION OF THE PREFERRED EMBODIMENTS

In the present invention, a high stress retention nitrile glove with thickness about 0.05-0.30 mm, stress retention at 100% stretch more than 50%, tensile strength more than 17 Mpa and elongation more than 550% is made from a carboxylated nitrile butadiene elastomer comprising 20-30% acrylonitrile, 63-77% butadiene and 3-7% carboxylic acid dry weight of elastomer crosslinked by aluminum ion compound selected from sodium aluminate, aluminum oxide, aluminum hydroxide or its combination to form ionic bond and polyethylene glycol compound made from ethylene glycol derivative, dialdehyde derivative or its combination to form covalent bond. To prepare carboxylated nitrile latex compound for glove dipping process, the above mentioned diluted crosslinking agent is slowly adding in a raw carboxylated acrylonitrile butadiene elastomer latex; and then optional adding milled and diluted sulfur, accelerator or zinc oxide; and then other chemicals selected from the group comprising titanium dioxide, coloring agent, wax, anti-foam agent, anti-oxidant, dispersing agent, stabilizer or biocide agent; and finally adding a diluted potassium hydroxide or ammonia to adjust pH value of latex compound about 9 toll, and diluting latex compound by water to bring the total solid content to about 10-35% and continuously agitating for about 24-48 hours for maturation, and then it is ready to use for glove making process.

The prevent invention glove is made by following step:

A) A cleaned ceramic glove former dip in a coagulant solution comprising about 10-30% calcium nitrate and optional with nonionic wetting agent, dispersing agent or stripping agent such as calcium stearate and calcium carbonate.
B) Drying coagulant and dip in a latex compound to form a layer of film on the former or optional dip another latex compound to get the desired film thickness.
C) Partially drying the film and dip in worm water to leach out the impurities of film such as calcium nitrate and surfactants.
D) Curing the film in oven by hot air with temperature range about 110-150° C. for about 20-30 minutes.
E) The film now is a glove and further treated with chlorination or polymer coating or powdering glove surface for de-sticky.

In various embodiments, a carboxylated nitrile latex with about 45% solid carboxylated nitrile elastomer is selected and comprising about 26-28% acrylonitrile, 66-69% butadiene and 5-6% carboxylic acid dry weight of elastomer. The prepared latex compound with a total solid content about 30%, pH about 9.5 and is maturated for about 24 hours. The sample gloves with thickness about 0.1 mm made by above mentioned dipping method and with a curing condition of 125° C. for 20 minutes. TABLE 1 shows crosslinking agent composition ratio and sample gloves physical performance test result according to ASTM D6319 and ASTM D412 test method, and the durability test is carried by 6 person wearing individual glove and operating in room condition until the glove broken and record the average wearing time.

TABLE 1

| Sample No. | 1 | 2 | 3 | 4 | 5 |
|---|---|---|---|---|---|
| Composition ratio (phr) | | | | | |
| XNBR-1 | 100 | 100 | 100 | 100 | 100 |
| Aluminum ion derivatives | 1.0 | 1.0 | 1.0 | | |
| Polyethylene glycol compound | 2.4 | 1.0 | | 1.0 | |
| Zinc oxide | | | | | 1.0 |
| Physical performance | | | | | |
| Stress retention at 100% | 63 | 54 | 51 | 61 | 39 |
| stretch (%) | | | | | |
| Stress at 300% stretch (Mpa) | 3.2 | 5.6 | 8.5 | 1.4 | 9.2 |
| Stress at 500% stretch (Mpa) | 6.5 | 17.4 | 25.6 | 2.1 | 32.1 |
| Tensile strength at break (Mpa) | 35.5 | 28.4 | 27.9 | 11.8 | 37.7 |
| Elongation at break (%) | 749 | 630 | 560 | 1022 | 471 |
| Wearing durability at break (hour) | >4 | >4 | 3 | >4 | <1 |

According to the test result, it is noted that the more metallic ion introduced, the higher of stress at 300% and 500% stretch and tensile strength at break increased and the elongation decreased, the stress retention and wearing durability may varied depend on the metallic ion type and the ratio of metal ionic bond and covalent bond formed; and the more polyethylene glycol compound introduced, the better of stress retention and wearing durability caused by covalent bond formed. Comparing stress retention and wearing durability of sample glove 3 and 5, sample glove 3 with aluminum ion derivatives as a sole crosslinking agent having wearing durability about 3 hours and stress retention about 51% and sample glove 5 with zinc oxide as a sole crosslinking agent having wearing durability less than one hour and stress retention about 39%. Therefore, by aluminum metallic ionic bond formed, the glove with no covalent bond formed still able to get an acceptable stress retention and wearing durability. Sample glove 1 and 2 using aluminum ion derivatives and polyethylene glycol compound as crosslinking agent with wearing durability are more than 4 hours, good tensile strength and acceptable stress retention more than 50%, but sample glove 2 having a high stress at 300% and 500%, the glove is stiff and not so comfortable for extended wearing. Sample glove 4 using polyethylene glycol compound as a sole crosslinking agent having an acceptable stress retention and good wearing durability better than sample glove 3, but with poor tensile strength and low stress at 300% and 500% stretch, the glove is too soft, easy to break and difficult to strip off from the former.

In various embodiments, a carboxylated nitrile latex is selected with about 45% solid content comprising about 22-24% acrylonitrile, 71-75% butadiene and 3-5% carboxylic acid dry weight of elastomer. The latex compound prepared and sample gloves made by the above mentioned method as TABLE 1 except pH value is about 10.2, the crosslinking agent composition ratio and sample gloves physical performance and wearing durability are showing in TABLE 2.

TABLE 2

| | Sample No. | | | | | | | | |
|---|---|---|---|---|---|---|---|---|---|
| | 6 | 7 | 8 | 9 | 10 | 11 | 12 | 13 | 14 |
| Composition ratio | | | | | | | | | |
| (phr) | | | | | | | | | |
| XNBR-2 | 100 | 100 | 100 | 100 | 100 | 100 | 100 | 100 | 100 |
| Aluminum ion | 0.6 | 0.8 | 1.0 | 1.2 | 1.0 | 1.2 | | | 0.6 |
| derivatives | | | | | | | | | |
| Polyethylene | 0.6 | 0.8 | 1.0 | 1.2 | 2.0 | 2.4 | | | 0.6 |
| glycol compound | | | | | | | | | |
| Zinc oxide | | | | | | | 1.2 | 0.1 | |
| Sulfur | | | | | | | 1.0 | 3.5 | 1.5 |
| Zinc di-n-butyl | | | | | | | 0.8 | 2.0 | 1.0 |
| dithiocarbamate | | | | | | | | | |
| Physical | | | | | | | | | |
| performance | | | | | | | | | |
| Stress retention at | 56 | 59 | 60 | 61 | 62 | 66 | 43 | 67 | 69 |
| 100% stretch (%) | | | | | | | | | |
| Stress at 300% | 1.5 | 1.7 | 2.6 | 3.4 | 2.8 | 3.1 | 11.3 | 2.5 | 2.0 |
| stretch (Mpa) | | | | | | | | | |
| Stress at 500% | 2.79 | 3.95 | 5.4 | 7.1 | 5.1 | 5.2 | 36.7 | 14.3 | 13.9 |
| stretch (Mpa) | | | | | | | | | |
| Tensile strength at | 18.1 | 18.7 | 19.8 | 29.5 | 22.3 | 28.1 | 39.2 | 16.7 | 23.8 |
| break (%) | | | | | | | | | |
| Elongation at | 895 | 875 | 785 | 717 | 784 | 758 | 527 | 570 | 670 |
| break (%) | | | | | | | | | |
| Wearing | 1.4 | 1.8 | 2.3 | 2.5 | >4 | >4 | >4 | >4 | >4 |
| durability at break | | | | | | | | | |
| (hour) | | | | | | | | | |

It is noted that by using a lower content acrylonitrile and carboxylic acid of carboxylated nitrile elastomer as TABLE 2 selected, the performances of stress retention, stress at 300% and 500% stretch and elongation are better but tensile strength are lower than high content one as TABLE 1 selected. The TABLE 2 sample glove are softer, easy to stretch and more comfortable to wear for extended wearing. Sample glove 6-9 using 1.2-2.0 phr crosslinking agent comprising 50% aluminum ion derivatives and 50% polyethylene glycol compound of carboxylated nitrile elastomer, having an average stress retention about 55%, stress at 300% about 2.3 Mpa, stress at 500% stretch about 4.7 Mpa, tensile strength at break about 19.5 Mpa, and elongation about 823%, and the average wearing durability is poor only about 2 hours before broken, and comparing to sample glove 12-14 with conventional sulfur crosslinking agents are able to wear more than 4 hours. In order to improving durability, additional polyethylene glycol compound increased to double dosage amount, and result to sample glove 10 and 11 wearing durability extended to more than 4 hours and the stress retention also improved accordingly. Sample glove 12 using conventional formula of sulfur, accelerator and zinc oxide as crosslinking agent, the glove tensile strength is good but stress retention is only about 43% is similar with market available glove and the glove is strong but stiff. Sample glove 13 using a high dosage of sulfur and accelerator with a minimum dosage of zinc oxide as prior approaches disclosed, the glove having a good stress retention 67% but tensile strength is low, and glove with strong sulfur odor, yellowish looking that decreased the glove market value and also increased accelerator allergy risk. Sample glove 14 using aluminum ion derivatives and polyethylene glycol compound composition ratio as sample glove 6 and with additional low dosage of sulfur and accelerator, the glove having a good stress retention 69% with acceptable lightly sulfur odor and yellowish. Sample glove 10 and 11 by using the present invention crosslinking agent compound without sulfur, accelerator and zinc oxide, and the glove having an average stress retention about 64%, stress at 300% stretch about 3.0 Mpa, stress at 500% stretch about 5.2 Mpa, tensile strength about 25.2 Mpa and elongation greater about 771%, wearing durability greater than 4 hours, the glove is hand-fitting, strong but soft and more comfortable for extended wearing than current market available nitrile glove and suitable to making surgical glove.

What is claimed is:

1. A glove with thickness from about 0.05 mm to 0.3 mm having stress retention greater than 50% at 100% stretch, tensile stress at break greater than 17 Mpa and elongation at break greater than 550% is made from a carboxylated acrylonitrile butadiene elastomer comprising 20-30% acrylonitrile, 63-77% butadiene and 3-7% carboxylic acid dry weight of elastomer and crosslinked by 1.0-4.0 phr aluminum ion compound.

2. A glove according to claim 1, wherein aluminum ion compound comprising 10-90% aluminum ion derivatives selected from sodium aluminate, aluminum oxide, aluminum hydroxide or its combination, and 90-10% polyethylene glycol compound selected from ethylene glycol derivatives, dialdehyde derivatives or its combination.

3. A glove according to claim 1, wherein carboxylated nitrile elastomer optional comprising less than 2.0 phr sulfur, less than 1.5 phr accelerator or less than 0.5 phr of zinc oxide.

4. A glove according to claim 1, wherein the glove is made by following steps:
a) A glove former dip in coagulant solution comprising about 10-30% calcium nitrate.
b) Drying coagulant and dip in one or two carboxylated acrylonitrile butadiene elastomer latex compound to form a desired thickness of film.
c) Partially drying the film and dip in worm water to leach out the impurities.
d) Curing the film in oven by hot air with temperature about 110-150° C. for 20-30 minutes.
e) Glove with chlorination or polymer coating or powdering treatment to de-sticky the glove surface.
